(19) United States
(12) Patent Application Publication
(10) Pub. No.: US 2012/0144467 A1
(43) Pub. Date: Jun. 7, 2012

(54) Network Selection from a Menu

(75) Inventors: Alex Ainslie, San Francisco, CA (US); Nicholas Jitkoff, Palo Alto, CA (US)

(73) Assignee: Google Inc., Mountain View, CA (US)

(21) Appl. No.: 12/961,418

(22) Filed: Dec. 6, 2010

(51) Int. Cl. G06F 3/048; H04L 9/32; G06F 21/00; G06F 15/16

(52) U.S. Cl. 726/7; 715/739

(57) ABSTRACT

Methods and systems for connecting to a network, such as a wired or wireless network, are provided. A method may include displaying a menu with one or more menu options in response to a user indication. Each menu option may indicate an available network and the status of the available network. Upon receiving a user menu selection indicating a selected available network, an authentication input field may be provided with the corresponding menu option in the displayed menu. The user may enter authentication information in the authentication input field in order to be connected to the selected available network. The corresponding menu option may display further status information upon successful connection to the selected available network.

### BACKGROUND

1. Technical Field

The field relates to network connectivity for computing devices.

2. Background

Businesses and consumers increasingly use wired and wireless networking to enable access to the Internet and/or corporate networks. As computer security becomes more of a concern for users of such networks, various protection methods have been created and implemented to protect data on a network from outside attack. Many of these protection methods involve a password or passphrase or other credentials that must be entered before a successful connection to a network can be established.

In order to connect to a desired wired or wireless network, a user may select a particular network he wishes to connect to in a window listing all available networks. Upon selecting the network, a new window may appear to allow the user to enter in the desired password or other credentials. However, if the user mistakenly selected the wrong network, he may have to return to the first window to select the correct network. If a number of networks appear with similar names, this process may be repeated many times. Additionally, on computing devices with small screens, extra windows fill valuable screen space.

### BRIEF SUMMARY

In an embodiment, a method for connecting to a network is provided. In response to a user indication, a menu with one or more menu options may be displayed. Each menu option may indicate an available network and a status of the available network. The user may select a desired network. Upon receiving a user menu selection indicating a selected available network, an authentication input field may be provided for the selected available network. The authentication input field may be displayed along with the corresponding menu option in the display menu. If the user enters the correct authentication information, the user may then be connected to the network, and the menu option may display details regarding the current connection.

According to another embodiment, a system for connecting a user to a network may include a connection manager for determining status and authentication information of available networks. Additionally, the system may include a menu manager that displays a menu containing one or more menu options. Each menu option may indicate an available network and a status of each available network. The system also includes a user input manager that receives a user menu selection that may include a selected available network. The user input manager may also provide an authentication input field to obtain authentication information for the selected available network. The menu manager may be configured to display the authentication input field with the corresponding menu option in the display menu.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments are described below with reference to the accompanying drawings. In the drawings, like reference numbers may indicate identical or functionally similar elements. The drawing in which an element first appears is generally indicated by the left-most digit in the corresponding reference number.

FIG. 1 is an illustration of an exemplary network, such as a wireless network.

FIG. 2 is an illustration of an exemplary system for connecting a user to a network in accordance with embodiments.

FIG. 3 is a flow diagram of a method of connecting a user to a network, such as a wireless network, in accordance with embodiments.

FIGS. 4A-4F are exemplary menus in accordance with embodiments.

FIGS. 5A-5B are exemplary menus in accordance with embodiments.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Networks, both wired and wireless, that allow any user with an appropriately configured computing device to use the network are becoming ubiquitous. For example, wireless networks are often created by a wireless router or other wireless access point and cover a given area, dependent on the particular hardware used. A wireless router allows one or more devices to connect to and become part of a wireless network. For example and without limitation, devices such as laptop computers, desktop computers, tablet computers, and mobile devices that connect to a wireless router usually possess a wireless adapter that may be either integrated into the device or may be an external peripheral. Often, the wireless router is connected to a wide area network such as the Internet. Consumers may connect their wireless router to a cable or digital subscriber line modem, which in turn connects the customer to the Internet. Businesses may use a similar method, or may connect their routers to a dedicated connection to the Internet.

The most common type of wireless network is known as a wireless local area network, or WLAN. A WLAN connects two or more devices through an access point, such as a router, which in turn connects to the Internet. In this way, a WLAN allows multiple computers to share one connection to the Internet. A WLAN also may allow devices connected to the WLAN to share resources, such as files.

A WLAN is also commonly known as a Wi-Fi network. The standard used to implement Wi-Fi networks is known as the IEEE 802.11 standard. Within the 802.11 standard, access points, routers, computing devices and wireless adapters may comply with any of the various protocols of the 802.11 standard, such as 802.11b, 802.11 g or 802.11n.

Networks complying with the 802.11 standard may also employ security algorithms or protocols that ensure that only authorized users may connect to the network, and further ensure confidentiality of communication between the user device and the access point. For example, wired equivalent privacy (WEP) and Wi-Fi protected access (WPA and WPA2) are two of the most commonly used security algorithms or protocols.

Connecting to a network protected by WEP, WPA, or WPA2 requires authentication information such as a password or passphrase. Depending on the security algorithm or protocol implemented, the password may be of a particular length and contain particular characters required by the security algorithm. For example, WPA2 requires a passphrase of between 8 and 63 ASCII characters. For other protection protocols, authentication information may include a user name and password combination.

To create a wireless network, a user may purchase a wireless access point or router, and connect it to their modem or other Internet connection. The user may then configure the wireless access point or router by specifying a wireless network name, also known as a SSID, and use WEP or WPA/WPA2 to protect their wireless network from being compromised.

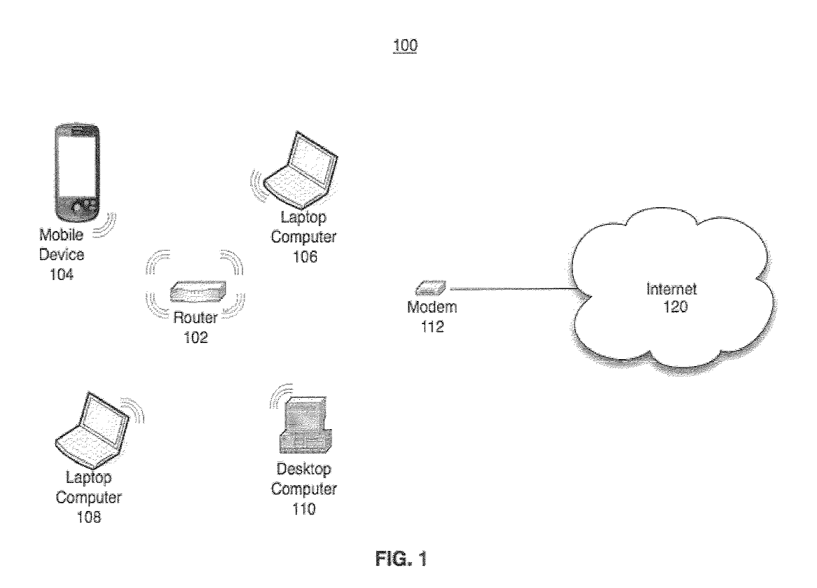

A typical network, such as a wireless network, and clients connecting to the wireless network may be shown in FIG. 1. Wireless router 102 of FIG. 1 may be a wireless router that complies with the 802.11 standard to provide wireless connectivity. Various devices, such as mobile device 104, laptop computers 106 and 108, and desktop computer 110, may connect to wireless router 102. In order to connect to wireless router 102, each device 104, 106, 108 and 110 may contain a wireless network module, such as an internal wireless adapter or external wireless adapter that complies with the 802.11 standard. Additionally, in order to connect to wireless router 102, each device may need to provide a password to connect to wireless router 102.

Wireless router 102 may connect to modem 112. Modem 112 may be a cable modem, digital subscriber line modem, or may provide a dedicated connection such as a T1, T3, OC3 or fiber optic connection. Modem 112 in turn may connect to the Internet 120.

Wireless networks may also be created by cellular towers. These wireless networks transmit data from a user device to the cellular tower, which allows connection to the Internet. Such wireless networks may be known as a 3G network, 4G network, WiMax network, and may use GSM or CDMA cellular technology.

A user device's operating system (OS) may provide a facility to connect a user to a wireless network. The OS may employ various elements of a graphical user interface (GUI) to enable a user to view available wireless networks and select a network to be connected to. Wireless networks may be listed by their SSID or network name. After selecting a desired SSID, if the selected wireless network is protected by WEP, WPA/WPA2, or another protection method, the OS may display an additional GUI window to allow a user to enter a passphrase. A further GUI window may be displayed upon successful connection to the network, or to notify the user of an error. However, displaying additional windows both interrupts the flow of a user's activity and may consume available real estate on the user's screen. Embodiments described below provide for a less intrusive manner to connect a computer to a wireless network.

### Example System

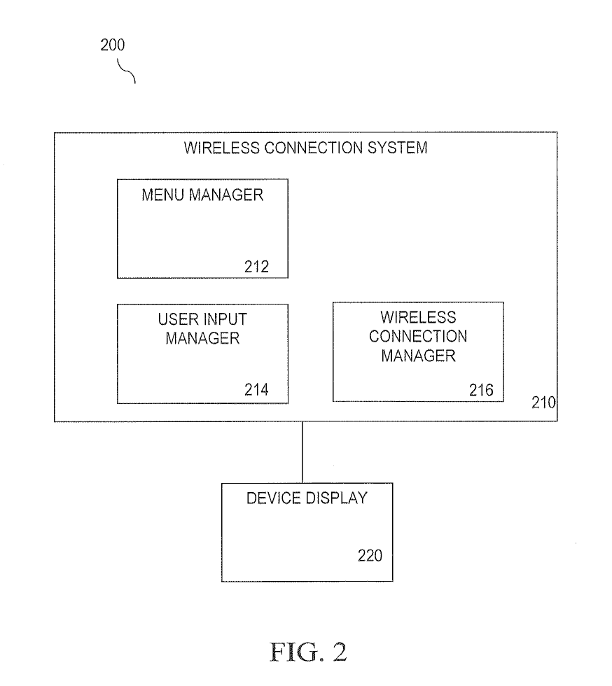

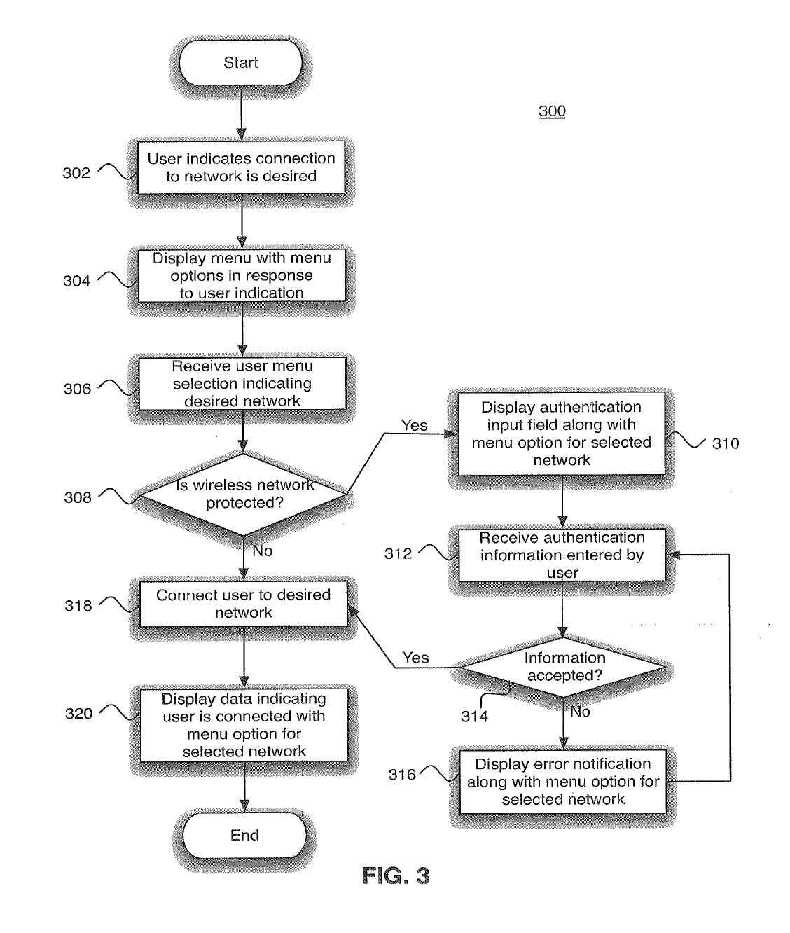

FIG. 2 is a drawing of an exemplary system 200 containing a wireless connection system 210 that may be used to implement embodiments disclosed herein. Wireless connection system 210 may be configured to execute exemplary method 300 of FIG. 3 described below to connect a user to a wireless network in accordance with an embodiment. Although wireless connection system 210 is described as used to connect a user to a wireless network, elements of wireless connection system 210 may be used to connect a user to other networks, including wired networks. Wireless connection system may use the same components as described below or may be implemented in conjunction with additional elements to connect a user to other networks. Wireless connection system 210, or any combination of its components, may be part of or may be implemented with a computing device. Examples of computing devices include, but are not limited to, a computer, workstation, distributed computing system, computer cluster, embedded system, stand-alone electronic device, networked device, mobile device (e.g. mobile phone, smart phone, navigation device, tablet or mobile computing device), rack server, set-top box, or other type of computer system having at least one processor and memory. Such a computing device may include software, firmware, hardware, or a combination thereof. Software may include one or more applications and an operating system. Hardware can include, but is not limited to, a processor, memory and user interface display. The various components of wireless connection system 210 may communicate with device display 220 as described below. Wireless connection system 210 may include menu manager 212, user input manager 214 and wireless connection manager 216.

According to an embodiment, menu manager 212 may be used by the operating system of the user's computer to cause device display 220 to display various menus for applications and other programs. Menu manager 212 may be configured to cause device display 220 to display the menu listing menu options for each available wireless networks and status information for each available wireless network in response to a user indication. Further, menu manager 212 may be configured to cause device display 220 to display an authentication input field with a menu option for a particular wireless network. Menu manager 212 may be further configured to cause device display 220 to display menus and menu options in accordance with the various steps of method 300, such as blocks 310, 316 and 320.

According to a further embodiment, menu manager 212 may be configured to obtain information about available wireless networks from an operating system or other network related applications. Some information may be instantly available. Other information may be obtained by executing certain network related applications. In some cases, menu manager 212 may coordinate with wireless connection manager 216 to obtain wireless network information. Menu manager 212 may also determine security settings and wireless networks to present to a user based on a user profile or security settings. Menu manager 212 provides for a more efficient way to collect, display and manage wireless connectivity. In many embodiments, a simple dropdown menu may provide access to all necessary information to connect to wireless networks.

Wireless connection system 210 may also include user input manager 214.

User input manager 214 may be configured to receive a user menu selection indicating a wireless network to be connected to, authentication information such as a password or passphrase for a particular wireless network, or any other input provided by a user, in accordance with blocks 302, 306 or 310. A user menu selection may be made in a number of ways, including clicking on the menu option from a displayed contextual menu. Menu manager 212, user input manager 214 and/or any combination of these components may be used to provide an interactive menu as described in the embodiments, including the steps shown in FIG. 3 and described below.

Wireless connection system 210 may also include wireless connection manager 216. According to an embodiment, wireless connection manager 216 may be an internal wireless card or external wireless card that is compliant with the 802.11 standard or other standard employed by the wireless network or networks the user wishes to connect to. Wireless connection manager 216 may be configured to determine status and authentication information of available wireless networks. According to a further embodiment, wireless connection manager 216 may be configured to coordinate with menu manager 212 to obtain information necessary to establish wireless connections, including secure or protected connections. In a further embodiment, wireless connection manager 216 may be configured to provide instant, dynamic and real time information to menu manager 212 and/or user input manager 214 so that such information could be displayed or updated in real time in the menu option of the menu.

### Example Method

In accordance with an embodiment, in order to connect a user device to a network, such as a wired or wireless network, a user may first select the desired network to be connected to. FIG. 3 is a flow chart of an exemplary method 300 for connecting a user to a wireless network. Method 300 may also be used and/or extended to connect a user to a wired or other network. At block 302, a user indicates that connection to a wireless network is desired. In response to the user indication, at block 304, a menu having one or more menu options is displayed. The user indication may be a user clicking on a particular icon that is part of the operating system GUI or taking a similar action.

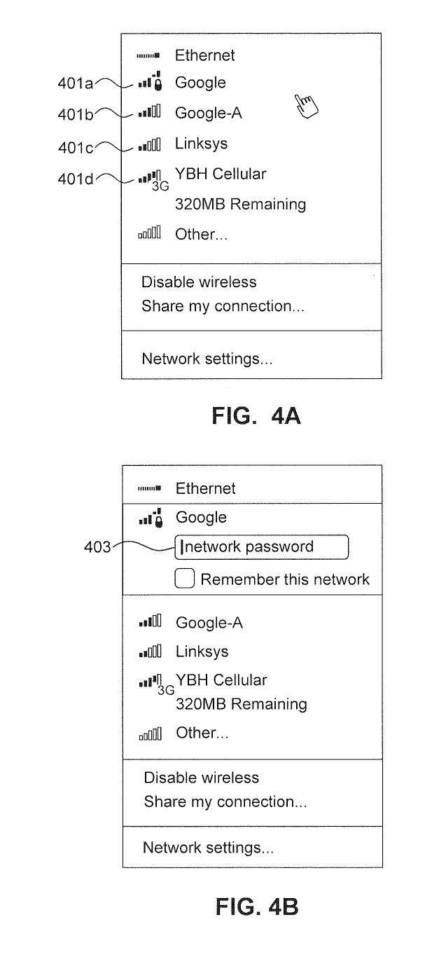

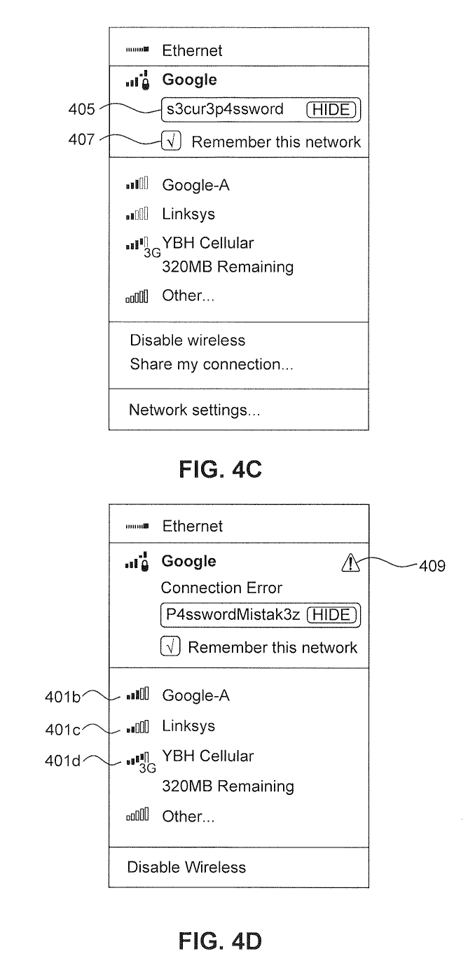

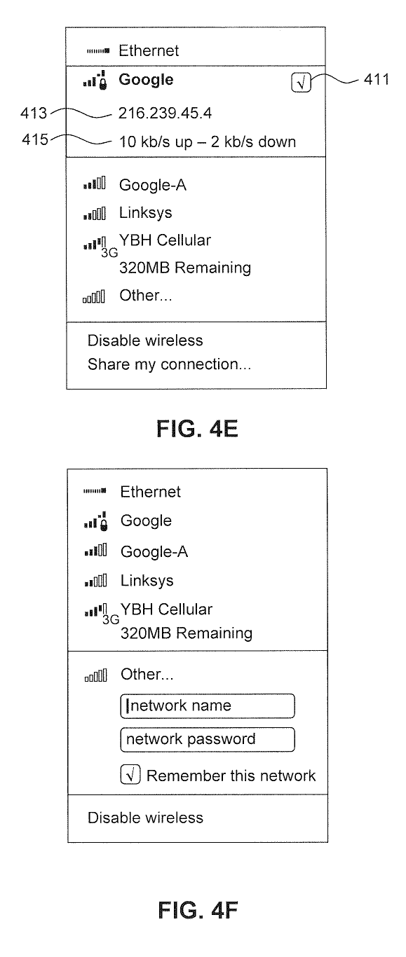

Each menu option may indicate or represent an available wireless network which is in range of the user's device. Each menu option may be associated with a particular SSID or network name. For example, the user may be presented with a menu such as that of FIG. 4A, which lists four wireless networks available to the user shown by 401a, 401b, 401c and 401d. Further, each menu option may indicate a status of the available wireless network with pertinent information related to the wireless network. For example, in the menu of FIG. 4A, the menu option for the wireless network named “Google” includes a status represented by the small lock icon 401a. The lock icon may represent that the network in question requires authentication and is password protected. Similarly, the menu option for the wireless network named “YBH Cellular” includes a status represented by the small “3G” notation 401d. This may represent that the network is a 3G Cellular network. The status accompanying each menu option may provide the user with an approximation of the signal strength of each wireless network. Additionally, as in the case of the wireless network “YBH Cellular”, the menu option may provide pertinent data regarding the particular connection, such as an amount of data that has been used.

The user device may be a laptop computer, desktop computer, mobile device, tablet computer, or any other suitable device for connecting to a network. Various types of access points and routers provide different wireless ranges for devices to be connected. For example, certain access points allow wireless network coverage over a 50 m radius. Other access points may allow for greater or lesser coverage.

The user may then select a menu option for a desired wireless network from the menu. At block 306, a user menu selection indicating a desired available wireless network is received. Such a menu selection may be triggered, for example and without limitation, by the user's action of clicking on a desired menu option for a wireless network. For example, a user may click on the network named “Google” shown in FIG. 4A, which in turn causes a user menu selection to be received which contains the desired network name. In response to the signal, the method moves to block 308.

At block 308, if the wireless network selected by the user requires authentication, the method proceeds to block 310. At block 310, an authentication input field is displayed along with the menu option for the selected wireless network. The authentication input field may accept a password or other authentication information required to connect to the wireless network desired by the user. The user may then enter the appropriate authentication information, such as a password or other credentials, to be connected to the desired wireless network. For example, if the network is protected by the WPA2 protocol, the user may enter the passphrase of appropriate length. Such an authentication input field 403 is shown in FIG. 4B. Authentication information may include any details necessary to connect to a particular access point, router, or network hardware. At block 312, the authentication info nation entered by the user 405 is received. The authentication information may be communicated to the access point or router in compliance with the 802.11 standard or other applicable standard.

At block 314, if the user's authentication information is accepted by the wireless access point or router, the method proceeds to block 318. At block 318, the user may be connected to the wireless network. At block 320, data indicating that the user is connected to the selected wireless network is displayed with the menu option for the selected wireless network. Such data may include, for example and without limitation, the current Internet Protocol (IP) address of the user's device and the data transmission rate.

If at block 314 the user's authentication information is not accepted by the wireless access point or router, the method may proceed to block 316. At block 316, an error notification may be displayed along with the menu option for the selected wireless network. Further, the authentication input field may allow the user to enter different authentication information. Upon entering authentication information, the authentication information is received at block 312.

If, at block 308, the wireless network corresponding to the menu option selected by the user is not protected by authentication, the method may proceed to block 318 directly. At block 318, the user is connected to the wireless network. At block 320, data indicating that the user is connected to the selected wireless network is displayed with the menu option for the selected wireless network, as above.

### Further Examples

Method 300 described above may be understood with reference to FIGS. 4A-4F, which are exemplary representations of a menu utilized in a method for connecting to a wireless network in accordance with embodiments. FIG. 4A, as described above, is a menu listing menu options for four wireless networks named “Google”, “Google-A”, “Linksys” and “YBH Cellular.” Such a menu may be displayed, in accordance with block 304 of method 300, in response to a user indication that a user wishes to connect to a wireless network, in accordance with block 302.

For each menu option, the various icons next to each network name may indicate the status of each wireless network, in accordance with an embodiment. For example, each icon 401a-401d may represent the approximate signal strength of the wireless network by shading in one or more bars of the icon. Additionally, the icon may include a small lock to indicate the wireless network is protected by a protocol such as WEP or WPA/WPA2 and requires a password or authentication information, such as icon 401a.

FIG. 4B is a menu with menu options for each wireless network. The menu option for the network “Google” displays an authentication input field 403 in accordance with block 310. The menu of FIG. 4B may be presented after a user indication has been received indicating that the user wishes to connect to the wireless network named “Google,” in accordance with block 306. Because the menu option for the wireless network selected by the user is protected by authentication, in accordance with block 308 and 310, the authentication input field 403 is displayed with the menu option in the displayed menu.

FIG. 4C is a menu similar to the menu of FIG. 4B that further includes user-entered authentication information 405 in the authentication input field. In an embodiment, the displayed menu option may provide a save control for saving the authentication information and wireless network. For example, save control 407 of FIG. 4C may allow the authentication information to be saved. Enabling the save control 407 may allow a user to be directly connected to a previously used wireless network when it becomes in range. For example, a user may wish to save his or her home or work network, or other network that is frequently used, so that he may skip the above steps of entering his or her authentication information.

In an embodiment, the menu with menu options for available wireless networks may be display an error notification message, in accordance with block 316 of method 300. For example, the yellow triangle 409 of FIG. 4D may indicate to the user that an error occurred while connecting to the desired wireless network. The error may be related to a failure of the wireless access point or router, or may be caused by incorrect authentication information. The menu may further display additional information about the particular error.

FIG. 4E is a further menu and menu option in accordance with blocks 318 and 320 of method 300. If the authentication information entered by the user in the authentication input field of the menu option of FIG. 4C is correct, in accordance with block 314, the user may be connected to the desired wireless network in accordance with block 318. As described with respect to block 320, after the user is connected to the wireless network, the menu may display various status information with the corresponding menu option in the displayed menu. FIG. 4E includes a check mark 411 to indicate a successful connection, as well as an IP address 413 and transmission rate notification 415.

In an embodiment, the menu option for an available wireless network may provide a view control that allows the user to hide or mask the authentication information being entered. This may be useful, for example, if a user is concerned about the protection of his or her wireless authentication information. For example, if a user is sitting near a user who should not be permitted access to the particular wireless network, he or she may wish to hide his or her authentication information so that it is not detected by other users.

In an embodiment, the menu options for each available wireless network may be ordered according to specific criteria in the displayed menu. For example, the menu may list menu options for frequently used networks at the top of the menu, or menu options for networks with the best signal strength at the top of the list. Additionally, the menu of FIG. 4F contains a menu option for “Other.” Certain access points and routers allow the wireless network name to be hidden, providing an extra layer of security. For these wireless networks, authorized users must know both the name of the wireless network and any applicable authentication information or other credentials. Thus, to connect to such a wireless network, the user may click on the “Other” menu option. The menu option may display one or more authentication input fields for a user to enter the name of the wireless network and password in order to connect. This information may be displayed in the same menu option or menu list space of a dropdown menu.

As stated above, authentication information may include any details required to connect to a particular network. For example and without limitation, certain wireless networks may be created by mobile telephones or similar devices using Bluetooth® devices or other methods. For example, a mobile phone may be enabled for use as a modem or a broadband transceiver. The mobile phone may be added to the list of available access points and the device pairing information may be provided. Thus, authentication information may include details used to create and connect to a wireless network. Additionally, authentication information may include details used to create and/or connect to a wired network.

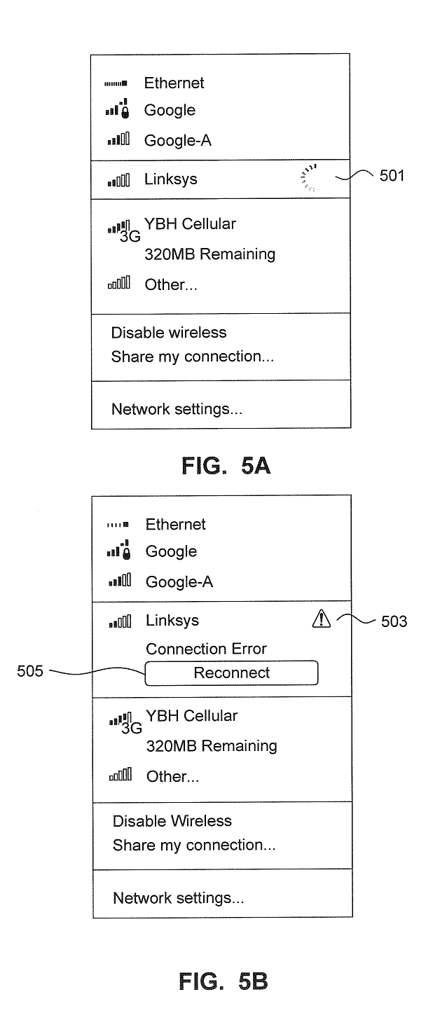

Method 300 described above may also be understood with reference to FIGS. 5A-5B, which are exemplary representations of a menu utilized in a method for connecting to a wireless network in accordance with embodiments.

FIG. 5A is a menu listing menu options for four wireless networks named “Google”, “Google-A”, “Linksys” and “YBH Cellular.” Such a menu may be displayed, in accordance with block 304 of method 300, in response to a user indication that the user wishes to connect to a wireless network, in accordance with block 302.

Further, FIG. 5A is an exemplary display of a menu with a menu option for the network named “Linksys” displaying a status indication representing that connection to the network named “Linksys” is in progress. In accordance with block 306, the menu of FIG. 5A may be displayed after a user indication has been received indicating that the user wishes to connect to the network named “Linksys”. For example, circle 501 of FIG. 5A may be an animated notification indicating to the user that connection to the wireless network is progressing. For a network that requires authentication, the status information also may indicate that the authentication information is being checked in accordance with block 314 to determine whether it is the correct authentication information for the desired network. In accordance with block 308, because the particular network is not protected by a security protocol, method 300 proceeds to block 310, and the user is connected to the desired network.

FIG. 5B is a further example display of a menu with a menu option indicating a connection error. Such a connection error may also be indicated by the yellow triangle 503. In an embodiment, the menu option for an available wireless network may provide a reconnect control 505 that allows the user to reconnect to a desired wireless network. For example, if, as described above, an error occurs when connecting to the desired wireless network, the reconnect control may allow a user to reattempt connection to the wireless network. This may be useful, for example, if the user suspects that the particular error is temporary.

In an embodiment, if the wireless network does not use a security protocol such as WEP or WPA/WPA2, the menu of FIG. 5A or the menu option for the wireless network may display to the user a warning detailing potential dangers of connecting to an unprotected wireless network before a successful connection can be established. Wireless networks not protected by WEP, WPA/WPA2 or other security protocols may send data from computing devices to the wireless access point without any encryption. A malicious user may be able to easily intercept the data from the user's device. If the user is using the Internet to conduct financial transactions, for example, a malicious user may be able to intercept the user's bank username and password and take control of his or her bank account.

A feature of embodiments disclosed herein is that the user is not confronted with much visual disturbance when connecting to a wireless network. Conventional methods and systems of connecting to a wireless network employ a series of different windows, which may not always contain all information needed by a particular user. Thus, users may need to jump back and forth between windows before they can connect to the wireless network and the Internet. Embodiments disclosed herein allow the flow of information to the user to be focused in one menu, potentially lessening the time for the connection process.

Additionally, a feature of embodiments disclosed herein may be useful for computing devices with minimal screen space, such as a tablet device or small laptop computer. Displaying multiple windows to a user, as conventional methods do, may quickly fill up the viewable screen area of the user's device. However, in embodiments disclosed herein, the entire process of connecting to a wireless network is confined to one menu, minimizing the amount of space taken from the user.

Aspects of the embodiments for exemplary system 200 and/or method 300 or any part(s) or function(s) thereof may be implemented using hardware, software modules, firmware, tangible computer readable or computer usable storage media having instructions stored thereon, or a combination thereof and may be implemented in one or more computer systems or other processing systems. Embodiments may be implemented via a set of programs running in parallel on one or more machines.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1-20. (canceled)

21. A computer-implemented method for connecting to a network, comprising:
receiving information including one or more available wireless networks, the information including a name of each wireless network and a status of each wireless network;
displaying, in response to a user indication, a menu comprising one or more menu options, wherein each of the one or more menu options indicates a name of an available wireless network and a status of an available wireless network based on the received information;
receiving a user menu selection indicating a selected available network;
providing an authentication input field for obtaining authentication information for the selected available network, wherein the authentication input field is displayed with the corresponding menu option in the displayed menu;
receiving authentication information for the selected available network; and
establishing a connection with the selected available network when the authentication information is accepted by a device associated with the selected wireless network.

22. The computer-implemented method of claim 1, further comprising:
displaying an error message when the authentication information is not accepted by the device associated with the wireless network, wherein the error message is displayed with the corresponding menu option in the displayed menu.

23. The computer-implemented method of claim 1, further comprising:
displaying a notification with the corresponding menu option in the displayed menu while the connection with the selected available network is being established.

24. The computer-implemented method of claim 1, wherein receiving authentication information for the selected available network includes receiving a user input from the authentication input field in the displayed menu including authentication for the selected available network.

25. The computer-implemented method of claim 1, wherein receiving authentication information for the selected available network includes accessing saved authentication information for the selected available network.

26. The computer-implemented method of claim 1, wherein at least one of the available wireless networks is a cellular network.

27. The computer-implemented method of claim 1, wherein at least one of the available wireless networks is a wi-fi network.

28. The computer-implemented method of claim 1, wherein the device associated with the selected wireless network is one of a wireless access point or a wireless router.

29. The computer-implemented method of claim 1, further comprising:
providing a save control for saving the authentication information with the corresponding menu option in the displayed menu.

30. A connection system for connecting to a network, comprising:
a connection manager, implemented with a computing device, configured to receive information including one or more available wireless networks, the information including a name of each wireless network and a status of each wireless network,
a menu manager, configured to display, in response to a user indication, a menu comprising one or more menu options, wherein each of the one or more menu options indicates a name of an available wireless network and a status of an available wireless network based on the received information;
a user input manager configured to receive a user menu selection indicating a selected available network and provide an authentication input field for obtaining authentication information for the selected available network,
wherein the menu manager is configured to display the authentication input field with the corresponding menu option in the displayed menu,
wherein the user input manager is configured to receive authentication information for the selected available network, and
wherein the connection manager is configured to establish a connection with the selected available network when the authentication information is accepted by a device associated with the selected wireless network.

31. The system of claim 10, wherein the menu manager is further configured to display an error message when the authentication information is not accepted by the device associated with the wireless network, wherein the error message is displayed with the corresponding menu option in the displayed menu.

32. The system of claim 10, wherein the menu manager is configured to display a notification with the corresponding menu option in the displayed menu while the connection with the selected available network is being established.

33. The system of claim 10, wherein at least one of the available wireless networks is a cellular network.

34. The system of claim 10, wherein at least one of the available wireless networks is a wi-fi network.

35. The system of claim 10, wherein the device associated with the selected wireless network is one of a wireless access point or a wireless router.

36. The system of claim 10, further comprising a wireless access module.

37. The system of claim 10, wherein the user input manager is further configured to provide a save control for saving the authentication information with the corresponding menu option in the displayed menu.

38. A computer usable storage medium having instructions stored thereon that, when executed by a processor, cause the processor to perform operations comprising:
displaying, in response to a user indication, a menu comprising one or more menu options, wherein each of the one or more menu options indicates an available network and a status of the available network;
receiving a user menu selection indicating a selected available network; and
providing an authentication input field for obtaining authentication information for the selected available network;
wherein the authentication input field is displayed with the corresponding menu option in the displayed menu.

39. The computer usable storage medium of claim 16, the operations further comprising:
providing a warning message with the corresponding menu option in the displayed menu when the desired network is not password protected.

40. The computer usable storage medium of claim 16, the operations further comprising:
providing a save control for saving the authentication with the corresponding menu option in the displayed menu.
